(19) United States
(12) Patent Application Publication
(10) Pub. No.: US 2010/0246941 A1
(43) Pub. Date: Sep. 30, 2010

(54) PRECISION CONSTRAINED GAUSSIAN MODEL FOR HANDWRITING RECOGNITION

(75) Inventors: Qiang Huo, Beijing (CN); Yongqiang Wang, Hefei (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/409,524

(22) Filed: Mar. 24, 2009

(51) Int. Cl. G06K 9/62; G06K 9/46; G06K 9/18

(52) U.S. Cl. 382/161; 382/228; 382/195; 382/185

(57) ABSTRACT

Described is a technology by which handwriting recognition is performed using a precision constrained Gaussian model (PCGM) that requires far less memory than other models such as MQDF. Offline training, such as via maximum likelihood and/or minimum classification error techniques, provides classification data. The classification data includes basis matrices that are shared by classes, along with weighting coefficients and a mean vector corresponding to each class. The base matrices and weights are obtained by expanding a precision matrix for each class. In online recognition, received handwritten input (e.g., an East Asian character) is classified into a class, based upon the per-class mean vector and weighting coefficients, and the basis matrices, by a PCGM recognizer that outputs similarity scores for candidates and a decision rule that selects the most likely class.

### CROSS-REFERENCE TO RELATED APPLICATION

The present application is related to copending U.S. patent application Ser. No. ______ (attorney docket no. 325293.01) entitled “Semi-tied Covariance Modeling for Handwriting Recognition,” filed concurrently herewith, assigned to the assignee of the present application, and hereby incorporated by reference.

### BACKGROUND

Handwriting recognition systems, particularly for East Asian languages such as Chinese, Japanese, and Korean, need to recognize thousands of characters. Contemporary recognition systems typically include a character classifier constructed based upon a modified quadratic discriminant function (MQDF). In general, the MQDF-based approach assumes that the feature vectors of each character class can be modeled by a Gaussian distribution with a mean vector and a full covariance matrix.

In order to achieve reasonably high recognition accuracy, a large enough number of the leading eigenvectors of the covariance matrix have to be stored. This requires a significant amount of memory to store the relevant model parameters. In general, the more memory, the better the recognition accuracy.

As a result, recognition accuracy is reduced when implementing an MQDF-based recognizer in a computing device having limited memory, such as a personal digital assistant, a cellular telephone, an embedded device and so forth. What is needed is a way to improve the accuracy versus memory tradeoff that is inherent in the MQDF-based approach, whereby devices having lesser amounts of memory can provide improved recognition accuracy.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which handwriting recognition is performed using a precision constrained Gaussian model that requires far less memory than other models such as MQDF. In one aspect, basis matrices that are shared by classes, along with weighting coefficients and a mean vector corresponding to each class, are computed and maintained. Received handwritten input is classified into a class based upon the per-class weighting coefficients, the basis matrices and the per-class mean vectors.

In one aspect, the base matrices and weights are obtained by expanding data corresponding to a covariance matrix, that is, a precision matrix, for each class, which may be accomplished in part by maximum likelihood and/or minimum classification error training. These classification data are loaded into a computing device, such as a mobile device containing a precision constrained Gaussian model recognizer, e.g., configured with a discriminant function that outputs similarity scores corresponding to candidate characters for an input character such as an East Asian character. A decision rule selects the most likely class (or classes) from among the candidates, e.g., to output a recognized character.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for recognizing handwritten input into a class via PCGM-based recognition.

FIG. 2 is a block diagram showing example components for training to obtain classification data used in PCGM-based recognition.

FIG. 3 is a flow diagram showing example steps taken to perform PCGM-based handwriting recognition.

FIG. 4 shows an illustrative example of a computing device into which various aspects of the present invention may be incorporated.

### DETAILED DESCRIPTION

Various aspects of the technology described herein are generally directed towards achieving handwritten character recognition accuracy that is similar to the recognition accuracy of MQDF-based approaches, yet with significantly less memory requirements. As will be understood, this is accomplished by modeling inverse covariance matrices by expansion of tied basis matrices, (in contrast to MQDF's modeling of the feature vectors of each character via a Gaussian distribution with a mean vector and a full covariance matrix).

While various examples are described herein, it should be understood that these are only examples. For example, while handwritten input is described as being recognized by classification as a character, it is understood that any input character symbol or figure, as well as any combination of characters symbols, and/or figures (e.g., words, phrases, sentences, shapes, and so forth) may be recognized as described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and recognition in general.

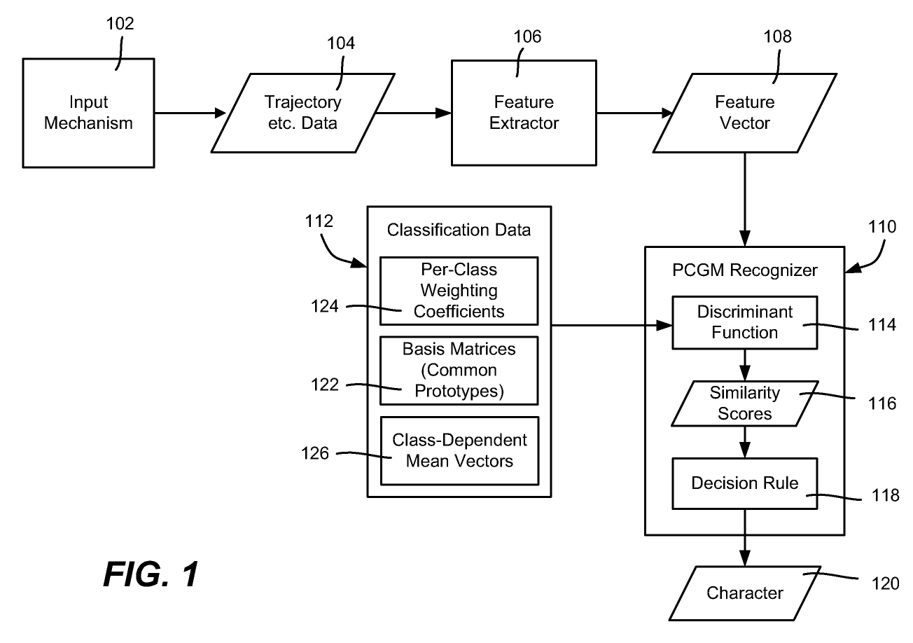

FIG. 1 shows various aspects related to a using a precision constrained Gaussian model (PCGM) to accomplish handwriting recognition in one implementation. A handwritten character is entered via a suitable input mechanism, such as a touch-screen digitizer 102. The corresponding ink data (e.g., strokes and timing, referred to as trajectory data 104 but possibly including other data) is received at a feature extraction mechanism 106, which outputs a feature vector 108 or the like in a known manner that is representative of the unknown character's features.

In general, a PCGM recognizer 110 then matches the unknown character's feature vector to feature vectors that represent known characters, e.g., maintained in the form of classification data 112 (such as obtained from training as described below). Note that the feature extraction mechanism 106 maybe considered part of the PCGM recognizer

To recognize a character, the PCGM recognizer 110 includes a PCGM discriminant function 114 that produces similarity scores 116, e.g., one for each candidate. A decision rule 118 selects the candidate with the best score and outputs it as a recognized character 120. Note that as with other recognizers, it is feasible to output more than one character depending on the application, e.g., a probability-ranked list of the top N most likely characters.

Unlike prior models, the classification data 112 that is used in the recognition needs significantly less storage than other models such as MQDF. In general, instead of storing a covariance matrix for each character, the classification data 112 comprises one or more sets of common data for all characters, plus a small amount of individual, per-character data. More particularly, the common data comprises a set of basis matrices 122, (also referred to herein as prototypes) that are common to the various character classes, while the per-character data comprises character-dependent expansion coefficients 124 and mean vectors 126, which in one implementation are scalars.

Thus, the PCGM technology described herein is able to maintain data representative of the known characters/feature vectors that are to be matched using far less memory; for example, instead of storing 10,000 relatively large covariance matrices for 10,000 characters, only on the order of 100 matrices need be stored, (with 10,000 far smaller sets of weighting coefficients).

The PCG model is based upon the feature vectors of each character class Cⱼ following a Gaussian distribution, i.e., p(x|Cⱼ)=N(x; μⱼ, Σⱼ), where mean μⱼ has no constraint imposed, while precision matrix Pⱼ=Σⱼ⁻¹ lies in a subspace spanned by a set of basis matrices (prototypes), ψ={Sₖ|k=1, . . . , K}, which are shared by the character classes. Consequently, the precision matrix Pⱼ can be written as:

$${P}_{j} {=}^{△} {\sum }_{k = 1}^{K} {λ}_{k}^{j} {S}_{k} \qquad ( 1 )$$

where λₖ^{j}'s are class-dependent basis coefficients and K is a control parameter. Note that the basis matrices Sₖ's are symmetric and not required to be positive definite, whereas Pⱼ's are.

Therefore, the set of PCG model parameters, Θ={Θ_{tied}, Θ_{untied}}, comprises a subset of tied parameters Θ_{tied}=ψ and a subset of untied parameters Θ_{untied}={μⱼ, [symbol] j=1 . . . M} where [symbol] =(λ₁^{j}, . . . , λ_{K}^{j})^{T}, and M is the number of character classes. The total number of parameters in one implementation of the PCG models is Kd(d+1)/2+M(K+d), which is much smaller than that of MQDF models, i.e., M(k+1)(d+1), if K is small compared with both M and d(d+1).

In the recognition stage, the following log likelihood function for unknown feature vector x is used as the discriminant function 114 (FIG. 1):

$${g}_{j} ( x ; Θ ) {=}^{△} \frac{1}{2} log det ( \frac{{P}_{j}}{2 π} ) - \frac{1}{2} {( x - {μ}_{j} )}^{T} {P}_{j} ( x - {μ}_{j} ) \qquad ( 2 )$$

The known maximum discriminant decision rule (shown in FIG. 1 as decision rule 118)

$$x ∈ {C}_{j} if j = arg {max}_{l} {g}_{l} ( x ; {Θ}_{l} )$$

can then be used for character classification. The computational complexity can be reduced by evaluating the right hand side of Equation (2) as follows:

$${g}_{j} ( x ; Θ ) = {b}_{j} + {x}^{T} {l}_{j} + {\sum }_{k = 1}^{K} {λ}_{k}^{j} {f}_{k} \\ where \\ {b}_{j} = log det ( \frac{{P}_{j}}{2 π} ) - \frac{1}{2} {μ}_{j}^{T} {P}_{j} {μ}_{j} , \\ {l}_{j} = {P}_{j} {μ}_{j} , \qquad ( 3 )$$

which can be pre-computed and cached; the “quadratic feature”

$${f}_{k} = - \frac{1}{2} {x}^{T} {S}_{k} x$$

only need be computed once for each feature vector x because it can be shared for all Gaussians.

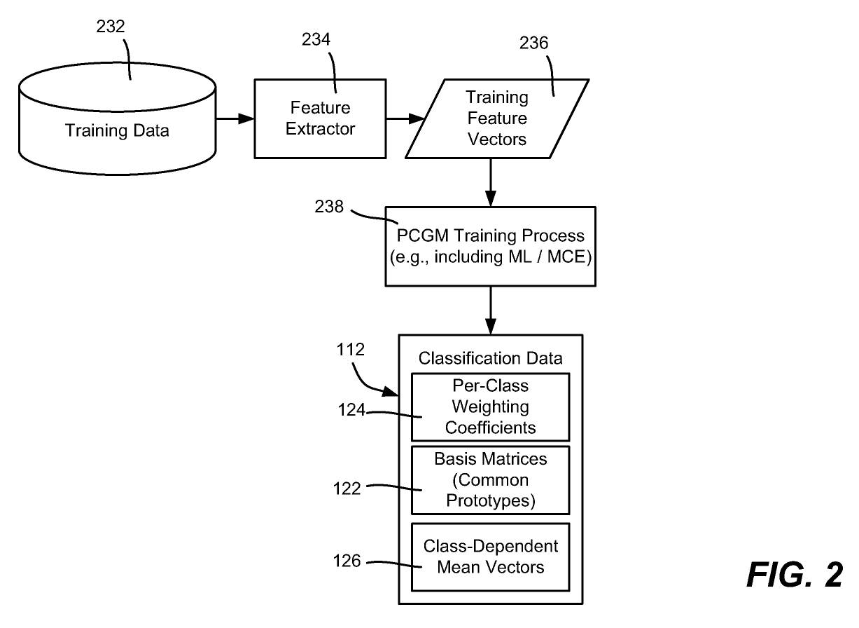

Turning to training, in general, training data 232 (FIG. 2) comprising samples each labeled with the appropriate class, is processed by a feature extractor 234 to produce training feature vectors 236. As described below, the training feature vectors 236 are then used by a PCGM training process 238 to estimate a mean feature vector 126 and the precision matrix for each character class, from which the weighting coefficients 124, along with the common basis matrices 122 are computed.

More particularly, training may be based on a maximum likelihood criterion. Given the set of training samples X, (labeled 232 in FIG. 2), the objective function of maximum likelihood (ML) training is defined as the following log likelihood function of the PCG model parameters Θ.

$$\begin{matrix}\begin{matrix} ( Θ \vert 𝒳 ) = {\sum }_{j = 1}^{M} {\sum }_{i = 1}^{{n}_{j}} log p ( {x}_{ji} \vert {C}_{j} , Θ ) \\ {\sum }_{j = 1}^{M} {n}_{j} \{ log det ( {P}_{j} ) - tr ( {\overline{Σ}}_{j} {P}_{j} ) - \\ {( {μ}_{j} - {\overline{μ}}_{j} )}^{T} {P}_{j} ( {μ}_{j} - {\overline{μ}}_{j} ) \} .\end{matrix} & ( 4 ) \\ {Θ}^{*} = arg {max}_{Θ} ( Θ \vert 𝒳 ) \\ subject to {∀}_{j} , {\sum }_{k = 1}^{K} {λ}_{k}^{j} {S}_{k} ≻ 0. & ( 5 )\end{matrix}$$

The optimal μ*ⱼ; is the sample mean μ̅ⱼ̅; the other parameters may be optimized by solving the optimization problem;

$$\begin{matrix}( {Ψ}^{*} , {Λ}^{*} ) = arg {max}_{{P}_{j} ≻ 0} ( Λ ; Ψ ) \\ where & ( 6 ) \\ ( Λ ; Ψ ) = {\sum }_{j = 1}^{M} {n}_{j} [ log det ( {P}_{j} ) - tr ( {\overline{Σ}}_{j} {P}_{j} ) ] \\ and = \{ {}_{j} ; j = 1 , … , M \} . & ( 7 )\end{matrix}$$

An overall ML training procedure to solve the above problem is summarized below in Algorithm 1, with additional details described herein

Algorithm 1:
Overall ML Training Procedure:

Input:

A set of training samples X.

Output:

{μⱼ, λₖ^{j}, Sₖ} (mean, coefficients, prototypes) that optimize the
objective function in Equation (4).

Step 1: Initialization

Estimate {μⱼ}
Initialize basis matrices Ψ and basis coefficients Λ.

Step 2: Alternate Optimization of Λ and Ψ.

for t = 0, . . . , T do

Optimization for basis coefficients Λ:

(8)

${Λ}^{( t + 1 )} = arg {max}_{{P}_{j} ≻ 0} ( Λ ; {Ψ}^{( t )} ) ;$

Optimization for basis matrices Ψ:

(9)

${Ψ}^{( t + 1 )} = arg {max}_{{P}_{j} ≻ 0} ( {Λ}^{( t + 1 )} ; Ψ ) .$

Step 3: Output Parameters

With respect to initialization, because the objective function of Equation (7) is highly nonlinear, optimization provides a way to start with reasonable initial

values for ψ and [symbol] A reasonably good initialization of ψ may be obtained by maximizing the following objective function:

$$Q ( Θ ) = - 0.5 {\sum }_{j = 1}^{M} {n}_{j} {‖ {\sum }_{k = 1}^{K} {λ}_{k}^{j} {S}_{k} - {( {\overline{Σ}}_{j} )}^{- 1} ‖}_{\overline{Σ}} , \qquad ( 10 )$$

where

$$\overline{Σ} = {\sum }_{j = 1}^{M} {n}_{j} {Σ}_{j} / {\sum }_{j = 1}^{M} {n}_{j} , {‖ Z ‖}_{\overline{Σ}}$$

is defined as tr( Σ̅Z Σ̅Z). This problem may be solved indirectly by finding the leading eigenvectors of an appropriately defined symmetric matrix. The following provides additional details of the initialization procedure:

Step 1: For each sample covariance Σ̅ⱼ, map it into a new vector
vⱼ ε R^{d(d+1)/2} as follows:

${υ}_{j} ← vec ( {{\overline{Σ}}^{\frac{1}{2}} ( {\overline{Σ}}_{j} )}^{- 1} {\overline{Σ}}^{\frac{1}{2}} ) ,$

where vec(·) is an operator on a symmetric matrix defined as a vector
containing the elements of the upper triangular portion of the matrix with
$the diagonal elements scaled by \frac{1}{\sqrt{2}} . That is , for a symmetric d \times d$
matrix X = [Xᵢⱼ],

$vec ( X ) = {( \frac{{X}_{11}}{\sqrt{2}} , {X}_{12} , \frac{{X}_{22}}{\sqrt{2}} , {X}_{13} , … , \frac{{X}_{dd}}{\sqrt{2}} )}^{T} .$

By using this mapping, ||vⱼ − vₖ||² is equal to ||( Σ̅ⱼ)⁻¹ − ( Σ̅ₖ)⁻¹|| _{Σ̅}.
Step 2: Let u₁, . . . , u_{K-1} be the leading K-1 eigenvector of
$V = {\sum }_{j = 1}^{M} {n}_{j} {υ}_{j} {υ}_{j}^{T} . By projecting vector {u}_{k} back to the corresponding$
symmetric matrix U_{K}, i.e., the inverse operation of vec(·) the initial Sₖ for
k = 1, 2, . . . , K − 1 is obtained as follows:

$( \overline{Σ} ) {\cdot }^{- \frac{1}{2}} {{U}_{k} ( \overline{Σ} )}^{- \frac{1}{2}} .$

Moreover, the last prototype S_{K} is initialized as

${S}_{K} ← {\sum }_{j = 1}^{M} {{n}_{j} ( {\overline{Σ}}_{j} )}^{- 1} / {\sum }_{j}^{M} {n}_{j} .$

Step 3: For all j, initialize Λⱼ as follows:

Λⱼ ← (0, 0, . . . , 0, 1)^{T}

By using this initialization scheme, Pⱼ=S_{K} for all j. Since S_{K} is guaranteed to be symmetric and positive definite, every Pⱼ is also symmetric and positive definite.

Regarding which set of parameters, [symbol] or ψ, to optimize first in Algorithm 1, note that when the above initialization approach is used, each precision matrix Pⱼ is initialized as S_{K}. If optimizing ψ first, only S_{K} is updated in the first cycle, which is not particularly effective in increasing the objective function; and thus is may be better to optimize ψ first. However, other initialization approaches may be used, whereby it may be better to optimize [symbol] first, e.g., to improve the objective function more effectively.

Turning to optimizing untied parameters ( [symbol] ) for the optimization problem in Equation (8), once the set of basis matrices ψ is fixed, different sets of basis coefficients [symbol] for different character classes are independent. Therefore, the original optimization problem can be further divided into M sub-problems, in which each amounts to finding an optimal Λ*ⱼ to maximize the following objective function:

[symbol]

(Λⱼ)=log det(Pⱼ)−tr( Σ̅ⱼPⱼ) (11)

while maintaining the positive definiteness of Pⱼ.

Because of the concavity of the function log det(•) and the linearity of the tr(•) function, the Hessian of the above objective function Lⱼ(•) is negative definite, provided Pⱼ is positive definite. Using Newton's method with a line search solves the above constrained optimization problem. Because the Hessian matrix is negative definite everywhere, the algorithm is guaranteed to converge to the global optimum [symbol] * from any arbitrary initial [symbol] ⁽⁰⁾.

As described herein, the algorithm first calculates the gradient and Hessian matrix of the objective function Lⱼ [symbol] ). Because the Hessian of the objective function is negative definite, the search direction ΔΛⱼ=(Δλ₁^{j}, . . . , Δλ_{K}^{j})^{T} is obtained by using Newton's method.

After determining the search direction Δ [symbol] , a step size α is needed such that the objective function is maximized, i.e., α is determined by a sub-problem in Equation (12).

$${α}^{*} = arg {max}_{α} {φ}_{j} ( α ) \\ subject to {P}_{j} ≻ 0 \\ where {φ}_{j} ( α ) = ( {Λ}_{j} + {αΔΛ}_{j} ) - ( {Λ}_{j} ) . \qquad ( 12 )$$

Evaluating φⱼ (α) and its first/second order derivatives can be done efficiently using Equation (13):

$$log \frac{det ( {P}_{j} + α {R}_{j} )}{det {P}_{j}} = {\sum }_{p = 1}^{d} log ( 1 + α {w}_{p}^{j} ) \qquad ( 13 )$$

where wₚ^{j} is the p-th eigenvalue of Pⱼ^{-1/2}RⱼPⱼ^{-1/2} and

$${R}_{j} = {\sum }_{k = 1}^{K} {Δλ}_{k}^{j} {S}_{k} .$$

The positive definiteness constraint Pⱼ+αRⱼ [symbol] 0 can be maintained if 1+αwₚ^{j}>0, ∀ⱼ, provided Pⱼ [symbol] 0.

The following describes one procedure for optimizing untied parameters:

Step 1: Calculate gradient and Hessian matrix
∇ [symbol] = (tr(ΞⱼS₁), . . . , tr(ΞⱼS_{K}))^{T},
H_{pq}^{j} = −tr(SₚPⱼ⁻¹S_{q}Pⱼ⁻¹)
where Ξⱼ = Pⱼ⁻¹ − Σ̅ⱼ, H_{pq}^{j} is the (p, q)-th element of the Hessian matrix
Hⱼ = ∇² [symbol] (Λⱼ).
Step 2: Calculate search direction
Given the gradient and Hessian matrix at current position, the search
direction for ΔΛⱼ is

ΔΛⱼ = −Hⱼ⁻¹∇ [symbol] .

Step 3: Line search
Given the search direction ΔΛⱼ, a line search module is invoked to find
an optimal step size α, such that φⱼ(α) is maximized. One example
procedure is as follows:

If for all p, wₚ^{j} > 0, let αₘₐₓ be +∞; else let αₘₐₓ be −minₚ 1/wₚ^{j}.
If αₘₐₓ = +∞,
Step 3.a: α₀ ← 0, t ← 0.
$Step 3. b \text{:} {α}_{t + 1} ← {α}_{t} - \frac{{φ}_{j}^{′} ( {α}_{t} )}{{φ}_{j}^{″} ( {α}_{t} )} . If {α}_{t + 1} < 0 , arbitrarily choose {α}_{t + 1} from$
(0, αₜ), e.g., αₜ₊₁ ← αₜ/2.
Step 3.c: t ← t + 1; goto step 3.b until ||φⱼ′(αₜ)|| ≦ ε₁.
If αₘₐₓ < +∞,
Step 3.a: α₀ ← 0, t ← 0.
$Step 3. b \text{:} {α}_{t + 1} ← {α}_{t} - \frac{{φ}_{j}^{′} ( {α}_{t} )}{{φ}_{j}^{″} ( {α}_{t} )} . If {α}_{t + 1} < 0 , arbitrarily choose {α}_{t + 1} from$
(0, αₜ), e.g., αₜ₊₁ ← α_{t/2}. If αₜ₊₁ > αₘₐₓ, arbitrarily choose αₜ₊₁ from
(αₜ, αₘₐₓ), e.g., αₜ₊₁ ← (αₜ + αₘₐₓ)/2
Step 3.c: t ← t + 1; goto step 3.b until ||φⱼ′(αₜ)|| ≦ ε₁

Step 4: Update untied parameters

Λⱼ ← Λⱼ + α* ΔΛⱼ

where α* is the optimal α found by the line search module.

Step 5: Repeat Steps 1-4 N_{untied} times.

To optimize tied parameters, various options are available, however one implementation uses the known Polak-Ribiere conjugate gradient (PR-CG) method to solve the optimization problem of Equation (9), as set forth below:

Step 1:

t ← 0.

Step 2: Calculate gradient

$\begin{matrix} {=}^{Δ} {( {( {∇}_{{S}_{1}} )}^{T} , … , {( {∇}_{{S}_{K}} )}^{T} )}^{T} \\ = {\sum }_{j = 1}^{M} {{n}_{j} ( {{λ}_{1}^{j} ( vec {Ξ}_{j} )}^{T} , … , {{λ}_{K}^{j} ( vec {Ξ}_{j} )}^{T} )}^{T} \\ where \\ {Ξ}_{j} = {P}_{j}^{- 1} - {\overline{\sum }}_{j} .\end{matrix}$

Step 3: Calculate search direction using PR-CG

Let ΔSₖ be the update direction of Sₖ, and Sₜ = ((vec ΔSₗ)^{T}, . . . ,
(vec ΔSₖ)^{T})^{T} be the search direction. Using Polak-Ribiere conjugate
gradient method, an ascent search direction Sₜ can be found as
follows:
$\begin{matrix} {S}_{t} = - {β}_{t} \\ where \\ {β}_{t} = \{ \begin{matrix}0 , & if \vert \cdot / \cdot \vert > {ε}_{2} or t = 0 \\ {\overline{β}}_{t} , & otherwise\end{matrix} \\ with \\ {\overline{β}}_{t} = \cdot ( - ) / ( \cdot ) .\end{matrix}$

Step 4: Line search

Once the update direction of Ψ is obtained, the line search module is
invoked to find an optimal αₜ^{*}, i.e,

${α}_{t}^{*} = arg {max}_{{P}_{j} ≻ 0} ( Λ ; {Ψ}_{t} + {αΔΨ}_{t} ) - ( Λ ; {Ψ}_{t} ) .$

Similar to the constrained optimization problem as described above,
this problem becomes another constrained optimization problem:

(17)

αₜ^{*} = arg max φ(α)

subject to ∀j and p, 1 + α wₚ^{j} > 0,

where
$\begin{matrix} φ ( α ) = {\sum }_{j = 1}^{M} {\sum }_{p = 1}^{d} log ( 1 + α {w}_{p}^{j} ) - α tr ( {\overline{\sum }}_{j} {R}_{j} ) \\ and \\ {R}_{j} = {\sum }_{k = 1}^{K} {λ}_{k}^{j} Δ {S}_{k} ,\end{matrix}$
wₚ^{j} is the p-th eigenvalue of Pⱼ^{-1/2}RⱼPⱼ^{-1/2}. For this constrained
optimization problem, there also exists one and only one optimal αₜ^{*}.
Let αₘₐₓ be calculated as:

${α}_{max} = \{ \begin{matrix}+ ∞ , & if {w}_{p}^{j} > 0 ∀ p , j \\ - {min}_{p , j} 1 / {w}_{p}^{j} , & otherwise ,\end{matrix}$

and substitute φⱼ(α) in the previously described steps for φ(α), the
same line search algorithm as above can be used to find out the
optimal step size αₜ^{*}.

Step 5: Update tied parameters

Ψₜ₊₁ ← Ψₜ + αₜ^{*}ΔΨₜ

Step 6: t ← t + 1.
Step 7: Repeat Steps 2-6 N_{tied} times.

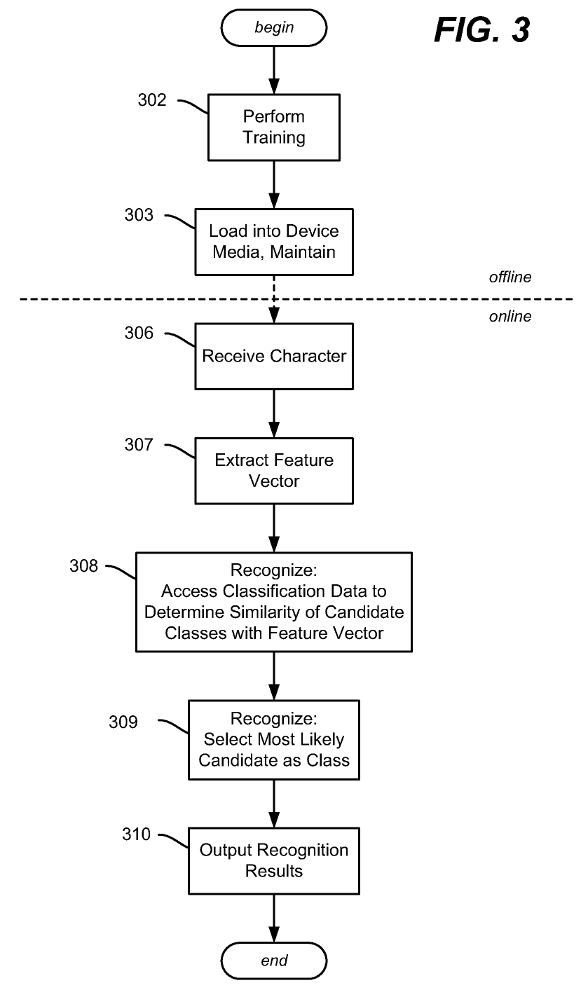

FIG. 3 summarizes various offline (steps 302 and 303) and online (steps 306-310) aspects of the technology, beginning at step 302 which represents the training procedure, which may include maximum likelihood and/or minimum classification error (MCE) operations. Training that includes minimum classification error aspects is described in the related patent application entitled “Semi-tied Covariance Modeling for Handwriting Recognition.”

Step 303 represents loading the classification data, e.g., storing it into some media on a computing device that will later perform online recognition. Note that the classification data may be maintained in a compressed form and then decompressed into other device memory when needed.

Steps 306 represents receiving handwritten input in some later, online recognition operating state. As can be readily appreciated, the input may be received at an operating system component that recognizes input and provides an output class for multiple applications, or at an application dedicated to recognition. Step 307 represents extracting the feature vector from the handwritten input.

Steps 308 and 309 perform the recognition, e.g., by accessing the classification data to determine similarity scores for candidate classes (step 308) and by selecting the most likely candidate as the class (or top N candidates in order, if desired, for subsequent automated or user selection of a class). Step 310 represents outputting the recognition results in some way, e.g., providing the class to an application, displaying the results, and so forth.

### Exemplary Operating Environment

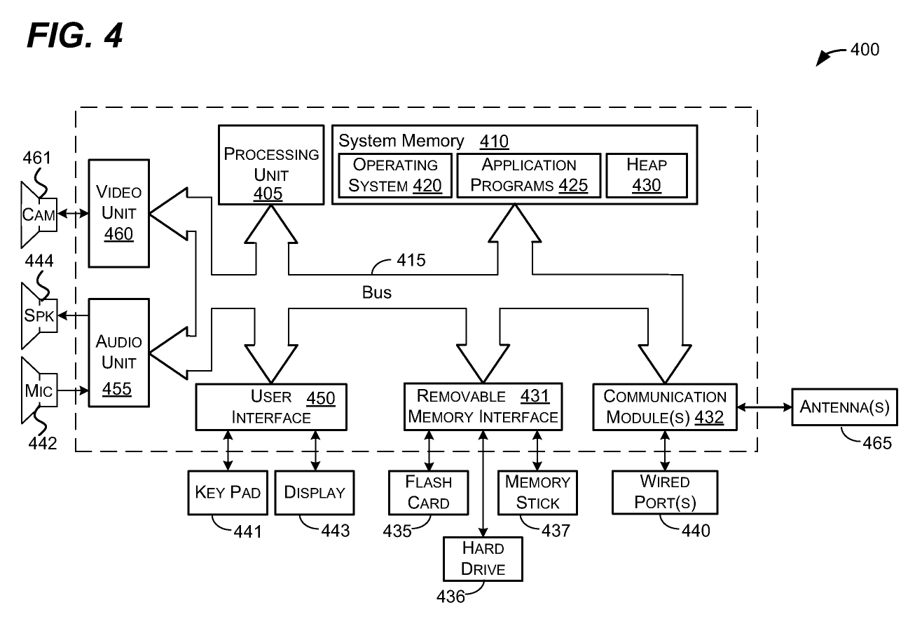

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 comprises a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated With the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-137 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a media playback device, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, maintaining basis matrices shared by classes, maintaining per-class weighting coefficients and mean vectors corresponding to each class, receiving handwritten input, and classifying the handwritten input based upon the per-class weighting coefficients, the mean vectors, and the basis matrices.

2. The method of claim 1 further comprising, extracting features of the handwritten input.

3. The method of claim 1 further comprising, performing training to obtain the basis matrices and the per-class weighting coefficients and mean vector.

4. The method of claim 3 wherein performing the training includes conducting maximum likelihood training to find model parameters.

5. The method of claim 3 wherein performing the training includes conducting minimum classification error training.

6. The method of claim 3 wherein training to obtain the basis matrices includes expanding data corresponding to a covariance matrix for each class as a weighted sum of a set of basis matrices.

7. The method of claim 6 wherein the data corresponding to the covariance matrix comprises a precision matrix.

8. In a computing environment, a system comprising, a feature extractor that obtains a feature vector from handwritten input, and a precision constrained Gaussian model recognizer that accesses basis matrices shared by classes and a per-class mean vector and per-class weighting coefficients corresponding to each class to classify the handwritten input as at least one character.

9. The system of claim 8 wherein the recognizer classifies the handwritten input as at least one East Asian character.

10. The system of claim 8 wherein the precision constrained Gaussian model recognizer includes a discriminant function that outputs similarity scores corresponding to candidate characters.

11. The system of claim 8 further comprising means for obtaining the basis matrices and the per-class mean vector and per-class weighting coefficients.

12. The system of claim 11 wherein the means for obtaining the basis matrices and the per-class weighting coefficients includes means for expanding a precision matrix for each class into a weighted sum of a set of basis matrices.

13. The system of claim 11 wherein the means for obtaining the basis matrices and the per-class weighting coefficients includes maximum likelihood training means.

14. The system of claim 11 wherein the means for obtaining the basis matrices and the per-class weighting coefficients includes minimum classification error training means.

15. The system of claim 8 wherein the recognizer, basis matrices and per-class weighting coefficients are maintained in a hand-held computing device.

16. One or more computer-readable media having computer-executable instructions, which when executed perform steps, comprising, receiving handwritten input, and recognizing the handwritten input as a class, including by determining similarity of data corresponding to features of the input with classification data by accessing basis matrices shared by classes, and weighting coefficients and a mean vector corresponding to each class in order to classify the handwritten input as the class.

17. The one or more computer-readable media of claim 16 having further computer-executable instructions comprising, loading the basis matrices, weighting coefficients and mean vectors from a first computing device into a second computing device that includes the computer-readable media.

18. The one or more computer-readable media of claim 16 wherein the class that is recognized comprises an East Asian character.

19. The one or more computer-readable media of claim 16 wherein recognizing the handwritten input comprises executing a precision constrained Gaussian model discriminant function to produce the similarity data.

20. The one or more computer-readable media of claim 16 wherein recognizing the handwritten input further comprises executing a decision rule that processes the similarity data to select the class.
